(19) United States
(12) Patent Application Publication
(10) Pub. No.: US 2019/0102745 A1
(43) Pub. Date: Apr. 4, 2019

(54) METHODS AND SYSTEMS FOR EVALUATING AN EMPLOYEE

(71) Applicants: Robert McConnell, Rancho Palos Verdes, CA (US); Michael Walsh, Long Beach, CA (US)

(72) Inventors: Robert McConnell, Rancho Palos Verdes, CA (US); Michael Walsh, Long Beach, CA (US)

(21) Appl. No.: 16/152,271

(22) Filed: Oct. 4, 2018

Related U.S. Application Data
(60) Provisional application No. 62/568,162, filed on Oct. 4, 2017.

(51) Int. Cl. G06Q 10/10

(52) U.S. Cl. CPC G06Q 10/1053

(57) ABSTRACT

An employee evaluation system is disclosed. The employee evaluation system may include a communication device configured for receiving a plurality of points corresponding to a plurality of categories associated with an employee from a user device. Further, the communication device may be configured for receiving a job data from the user device. Further, the communication device may be configured for transmitting a deployability score to the user device. Further, the employee evaluation system may include a processing device configured for calculating the deployability score associated with the employee based on the plurality of points and the job data. Further, the employee evaluation system may include a storage device configured for storing the deployability score in association with an employee identifier of the employee and the job data.

### FIELD OF THE INVENTION

The present invention relates generally to data processing. More specifically, the present disclosure describes methods and systems for evaluating employees.

### BACKGROUND OF THE INVENTION

It is challenging to efficiently find candidates for a particular job. Further, it is challenging for candidates to find jobs that would be most suitable for their growth based on their past experience. Conventional processes involve manual selection of candidates for a particular job. This implies that the selection involves subjective judgments. Accordingly, the conventional processes are inefficient and error-prone.

Further, conventional processes may assign objective values to profiles of candidates. However, often, they do not customize the values based on the specific jobs.

Therefore, there is a need for improved methods and systems for efficiently evaluating employees that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, an employee evaluation system is disclosed. The employee evaluation system may include a communication device configured for receiving a plurality of points corresponding to a plurality of categories associated with an employee from a user device. Further, the communication device may be configured for receiving a job data from the user device. Further, the communication device may be configured for transmitting a deployability score to the user device. Further, the employee evaluation system may include a processing device configured for calculating the deployability score associated with the employee based on the plurality of points and the job data. Further, the employee evaluation system may include a storage device configured for storing the deployability score in association with an employee identifier of the employee and the job data.

Further, according to some embodiments, a method for evaluating an employee is also disclosed. The method may include receiving, using a communication device, a plurality of points corresponding to a plurality of categories associated with an employee from a user device. Further, the method may include receiving, using the communication device, a job data from the user device. Further, the method may include calculating, using a processing device, a deployability score associated with the employee based on the plurality of points and the job data. Further, the method may include storing, using a storage device, the deployability score in association with an employee identifier of the employee and the job data. Further, the method may include transmitting, using the communication device, the deployability score to the user device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of the employee evaluation system, in accordance with various embodiments of the present disclosure.

FIG. 3 shows a method for evaluating an employee in accordance with some embodiments.

FIG. 4 shows a method of obtaining deployability scores in accordance with further embodiments.

FIG. 5 shows a method for processing resumes in accordance with further embodiments.

FIG. 6 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.” The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of evaluating employees, embodiments of the present disclosure are not limited to use only in this context. For example, the techniques disclosed herein may be used for evaluating individuals such as students for the purposes of admission into educational programs.

Overview

According to some embodiments, a system and method for generating a deployability score corresponding to how employable an individual is for a particular job industry is disclosed. Further, in some embodiments, the deployability score may be used for determining assignment of the employee to one or more teams and/or projects within an organization.

Further, an individual's personal history, their education, job history, skills, and certifications, are all quantifiable categories of information. With such details available and properly assessed, a number can be generated that would define how employable that individual is. The present disclosure is a system and method to find this number, which can be referred to hereinafter as the “Deployability Score”.

Further, the present disclosure factors each element of the individual's history with a different weight in the overall score. Even more, this score is job specific and identifies four main categories: Education, Certifications, Skills and Job History. The basic idea is that an individual does not have one unique score, but they rather have a score for a particular job industry. Thus, their score will vary from job to job, industry to industry.

In further embodiments, an individual's personal history, his education, job history, skills, and certifications, may be quantified and a score (“Deployability Score”) may be generated that may define how employable that individual is. Further, each element of an individual's history may have a different weight in the overall score.

For example, John Doe may have a high school diploma, 10 years' experience in different jobs, where he may have developed mostly handyman skills. For the past 3 years, he may have been working as a car mechanic for an auto dealership. For the past year, John Doe may have been going to a community college where he may have been learning about repairing computers and may like a career change where he may become an IT support specialist.

A points system may be defined to assign points to each element (such as education and work history) in John Doe's history. For example, the high school diploma may have X points, while the associates degree from the community college may have Y points. Each job may also be assigned points. Further, there is a need to modify the assigned points based on the new job application. Accordingly, each element value may be multiplied by a coefficient that may adjust the weight of that element in the overall score (the “Deployability Score”). Further, John Doe's experience as a car mechanic may be relevant even if he may like to work as a computer repair specialist, but his experience as a floor sales associate may have no relevance for a job in computer repairs.

Further, in some situations, a particular element might actually count against a candidate for a given job, and a negative effect may be encountered. For example, an individual could have a Master's degree but he is now looking for a cashier's job.

According to some embodiments, four main categories (listed below) may be identified.
Education
Certifications
Skills
Job history

Further, each main category may include subcategories. For example, the education category may include subcategories such as General Education Diploma (GED), Associates Degree, Bachelors, Masters, PhD. The skills category may include subcategories related to the different skills an individual may acquire in his lifetime (for example, carpenter, painter, expertise in MS Office, electrician, expertise in Quickbooks™, etc.). The certifications category may include subcategories related to the different certifications an individual may obtain. The job history category may be related to the different jobs along with their industry and length. Further, points for each job may depend on the job length. So, more points may be assigned to a job where a longer time is spent than a job where a shorter time is spent.

Further, the overall deployability score may be the sum of all points assigned to multiple categories/subcategories and adjusted for their weight for the given job industry the score is calculated for.

In an exemplary embodiment, equation 1 mentioned below may be used to determine the deployability score.

A=Σₖ₌₁⁴mₖ×i+Σ_{1⇐1}ⁿ(eₖ×i+cₖ×i+sₖ×i+((jₖ×i)+t)) (1)

wherein, mₖ is related to the four main categories (such that, m₁=Education, m₂=Certifications, m₃=Skills, m₄=Job history),

e=Points/Weights assigned to the education category,

eₖ=Points/Weights assigned to the education subcategories,

c=Points/Weights assigned to the certifications category,

cₖ=Points/Weights assigned to the certifications subcategories,

s=Points/Weights assigned to the skills category,

sₖ=Points/Weights assigned to the skills subcategories,

j=Points/Weights assigned to the job history,

jₖ=Points/Weights assigned to the job history subcategories,

t=time spent on a job,

i=industry coefficient adjustment for the given main category or subcategory.

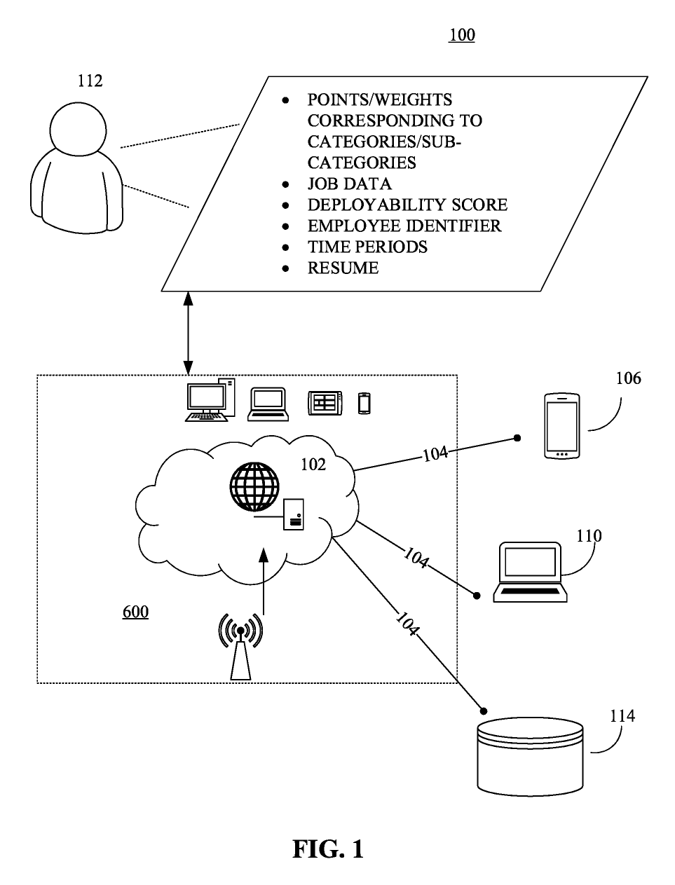

FIG. 1 is an illustration of an online platform 100 consistent with various embodiments of the present disclosure. By way of non-limiting example, the online platform 100 for evaluating an employee may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114 (such as job profile databases etc.), over a communication network 104, such as, but not limited to, the Internet. Further, users of the online platform 100 may include relevant parties such as, but not limited to, end users, and administrators. Accordingly, in some instances, electronic devices operated by the one or more relevant parties may be in communication with the platform 100.

A user 112, such as the one or more relevant parties, may access online platform 100 through a web-based software application or browser. The web-based software application may be embodied as, for example, but not be limited to, a website, a web application, a desktop application, and a mobile application compatible with a computing device 600.

According to some embodiments, the online platform 100 may be configured to operate in conjunction with an employee evaluation system 200 for evaluating an employee. The employee evaluation system 200 is explained in detail below.

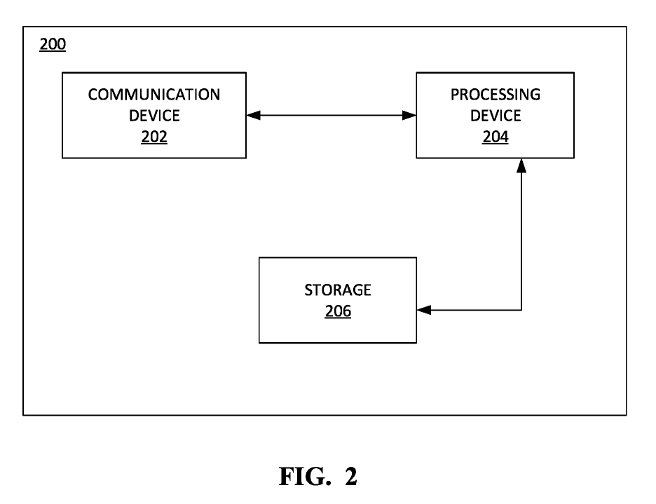

FIG. 2 is a block diagram of the employee evaluation system 200, in accordance with various embodiments of the present disclosure. The employee evaluation system 200 may include a communication device 202 configured for receiving a plurality of points corresponding to a plurality of categories associated with an employee from a user device. In some embodiments, the plurality of categories may include education, certifications, skills and job history.

In some embodiments, the plurality of categories corresponds to a plurality of weights. Further, each weight of the plurality of weights may be based on the job data. Further, the deployability score may be further based on the plurality of weights. In further embodiments, each weight may include an industry coefficient adjustment corresponding to the job data. Further, the job data may include one or more of a job type and an industry.

Further, the communication device 202 may be configured for receiving a job data from the user device. Further, the communication device 202 may be configured for transmitting a deployability score to the user device.

Further, the employee evaluation system 200 may include a processing device 204 configured for calculating the deployability score associated with the employee based on the plurality of points and the job data.

In some embodiments, the processing device 204 may be configured for generating the deployability score based on a weighted sum of the plurality of points. Further, the weighted sum may be based on an addition of a plurality of products of the plurality of points and a corresponding plurality of weights associated with the plurality of categories.

Further, the employee evaluation system 200 may include a storage device 206 configured for storing the deployability score in association with an employee identifier of the employee and the job data.

In some embodiments, at least one category of the plurality of categories may include a plurality of sub-categories. Further, the plurality of sub-categories may be associated with a plurality of sub-category points. Further, points associated with a category may be based on the plurality of sub-category points associated with the plurality of sub-categories of the category.

In some embodiments, the plurality of categories may be associated with a plurality of time periods. Further, the calculating of the deployability score may be further based on the plurality of time periods.

In some embodiments, a category of the plurality of categories may include a plurality of jobs. Further, the plurality of jobs corresponds to a plurality of time periods. Further, the calculating of the deployability score may be further based on the plurality of time periods.

In some embodiments, the communication device 202 may be further configured for receiving a deployability request from a requesting device. Further, the deployability request may include the employee identifier. Further, the communication device 202 may be configured for transmitting a plurality of deployability scores corresponding to a plurality of job data to the requesting device. Further, the plurality of deployability scores may be associated with the employee identifier. Further, the storage device 206 may be further configured for retrieving the plurality of deployability scores based on the employee identifier.

In some embodiments, the communication device 202 may be further configured for receiving a resume associated with the employee from the user device. Further, the processing device 204 may be further configured for analyzing the resume. Additionally, the processing device 204 may be configured for generating the plurality of points based on the analyzing.

Further, in some embodiments, the communication device 202 may be further configured for receiving a social score from the user device. The social score in general may be representative of social behavior of the employee. For instance, the social score may be based on volunteering activities performed by the employee. Accordingly, the calculating of the deployability score may be further based on the social score. For example, the employee may be awarded a higher social score for volunteering for community services, blood donation, social change initiatives etc. As a result, such positive social behavior may be recognized and rewarded by generating a higher deployability score for the employee.

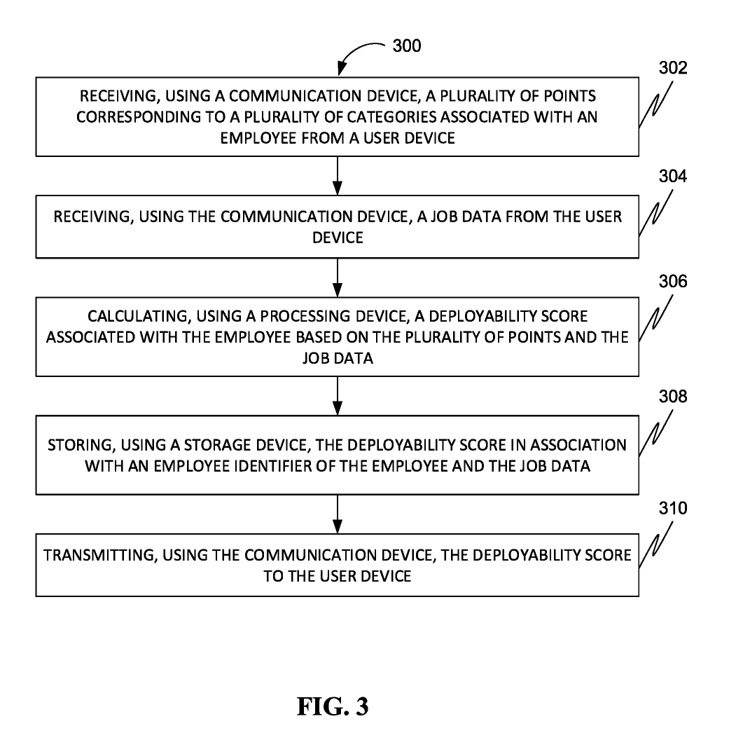

FIG. 3 shows a method 300 for evaluating an employee in accordance with an embodiment. At 302, the method 300 may include receiving, using a communication device (such as the communication device 202), a plurality of points corresponding to a plurality of categories associated with an employee from a user device. In some embodiments, the plurality of categories may include education, certifications, skills and job history.

In some embodiments, the plurality of categories corresponds to a plurality of weights. Further, each weight of the plurality of weights may be based on the job data. Further, the deployability score may be further based on the plurality of weights.

In further embodiments, each weight may include an industry coefficient adjustment corresponding to the job data. Further, the job data may include one or more of a job type and an industry.

Further, at 304, the method 300 may include receiving, using the communication device, a job data from the user device.

Further, at 306, the method 300 may include calculating, using a processing device (such as the processing device 204), a deployability score associated with the employee based on the plurality of points and the job data.

In further embodiments, the method 300 may include generating, using the processing device, the deployability score based on a weighted sum of the plurality of points. Further, the weighted sum may be based on an addition of a plurality of products of the plurality of points and a corresponding plurality of weights associated with the plurality of categories.

Further, at 308, the method 300 may include storing, using a storage device (such as the storage device 206), the deployability score in association with an employee identifier of the employee and the job data.

Further, at 310, the method 300 may include transmitting, using the communication device, the deployability score to the user device.

In some embodiments, at least one category of the plurality of categories may include a plurality of sub-categories. Further, the plurality of sub-categories may be associated with a plurality of sub-category points. Further, points associated with a category may be based on the plurality of sub-category points associated with the plurality of sub-categories of the category.

In some embodiments, the plurality of categories may be associated with a plurality of time periods. Further, the calculating of the deployability score may be further based on the plurality of time periods.

In some embodiments, a category of the plurality of categories may include a plurality of jobs. Further, the plurality of jobs corresponds to a plurality of time periods. Further, the calculating of the deployability score may be further based on the plurality of time periods.

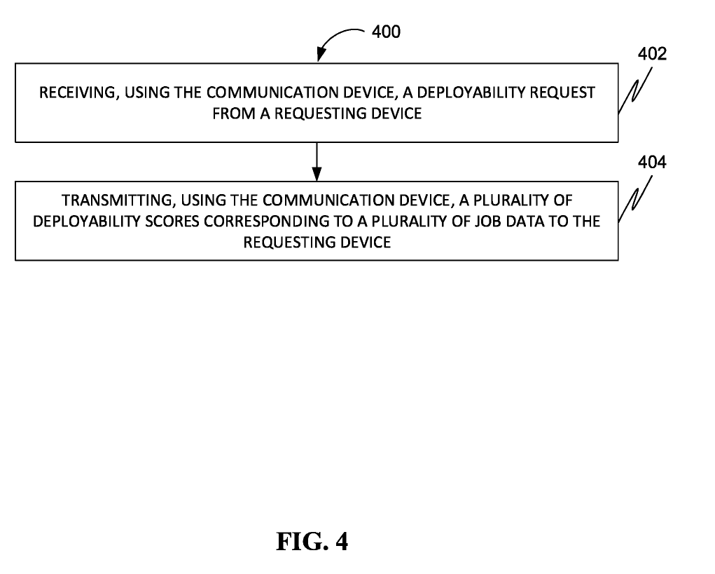

FIG. 4 shows a method 400 of obtaining deployability scores in accordance with further embodiments. At 402, the method 400 may include receiving, using the communication device, a deployability request from a requesting device. Further, the deployability request may include the employee identifier.

Further, at 404, the method 400 may include transmitting, using the communication device, a plurality of deployability scores corresponding to a plurality of job data to the requesting device. Further, the plurality of deployability scores may be associated with the employee identifier. Further, the storage device may be further configured for retrieving the plurality of deployability scores based on the employee identifier.

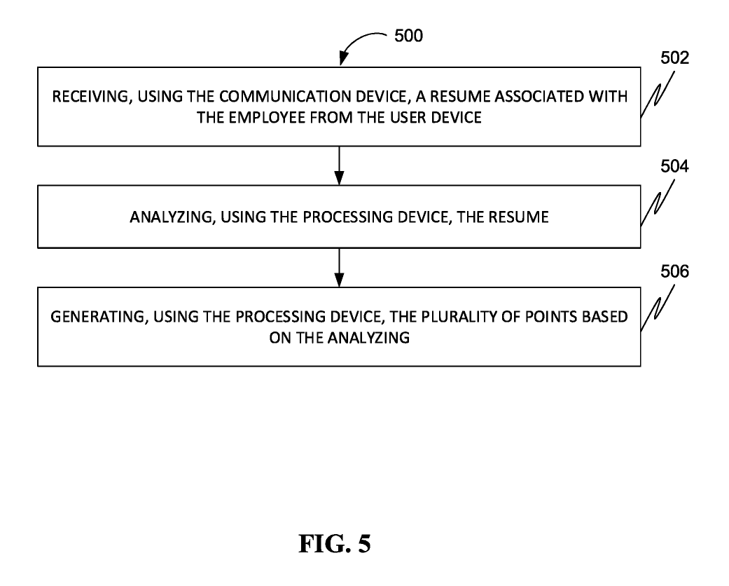

FIG. 5 shows a method 500 for processing resumes in accordance with further embodiments. At 502, the method 500 may include receiving, using the communication device, a resume associated with the employee from the user device. Further, at 504, the method 500 may include analyzing, using the processing device, the resume. Further, at 506, the method 500 may include generating, using the processing device, the plurality of points based on the analyzing.

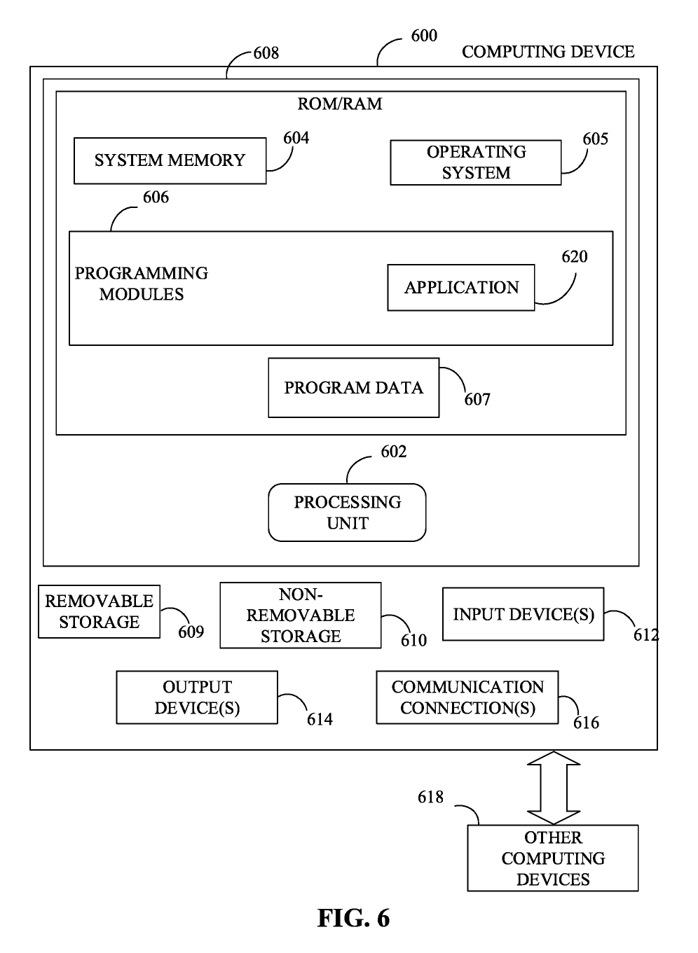

With reference to FIG. 6, a system consistent with an embodiment of the disclosure may include a computing device or cloud service, such as computing device 600. In a basic configuration, computing device 600 may include at least one processing unit 602 and a system memory 604. Depending on the configuration and type of computing device, system memory 604 may comprise, but is not limited to, volatile (e.g. random-access memory (RAM)), non-volatile (e.g. read-only memory (ROM)), flash memory, or any combination. System memory 604 may include operating system 605, one or more programming modules 606, and may include a program data 607. Operating system 605, for example, may be suitable for controlling computing device 600's operation. In one embodiment, programming modules 606 may include a machine learning module. Furthermore, embodiments of the disclosure may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer-readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, a location sensor, a camera, a biometric sensor, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g., application 620 such as a media player) may perform processes including, for example, one or more stages of methods, algorithms, systems, applications, servers, databases as described above. The aforementioned process is an example, and processing unit 602 may perform other processes. Other programming modules that may be used in accordance with embodiments of the present disclosure may include machine learning application etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

We claim:

1. An employee evaluation system comprising:
a communication device configured for:
receiving a plurality of points corresponding to a plurality of categories associated with an employee from a user device;
receiving a job data from the user device; and
transmitting a deployability score to the user device;
a processing device configured for calculating the deployability score associated with the employee based on the plurality of points and the job data; and
a storage device configured for storing the deployability score in association with an employee identifier of the employee and the job data.

2. The employee evaluation system of claim 1, wherein the plurality of categories comprises education, certifications, skills and job history.

3. The employee evaluation system of claim 1, wherein the processing device is configured for generating the deployability score based on a weighted sum of the plurality of points, wherein the weighted sum is based on addition of a plurality of products of the plurality of points and corresponding plurality of weights associated with the plurality of categories.

4. The employee evaluation system of claim 1, wherein the plurality of categories corresponds to a plurality of weights, wherein each weight of the plurality of weights is based on the job data, wherein the deployability score is further based on the plurality of weights.

5. The employee evaluation system of claim 4, wherein each weight comprises an industry coefficient adjustment corresponding to the job data, wherein the job data comprises at least one of a job type and an industry.

6. The employee evaluation system of claim 1, wherein at least one category of the plurality of categories comprises a plurality of sub-categories, wherein the plurality of sub-categories is associated with a plurality of sub-category points, wherein a points associated with a category is based on the plurality of sub-category points associated with the plurality of sub-categories of the category.

7. The employee evaluation system of claim 1, wherein the plurality of categories is associated with a plurality of time periods, wherein the calculating of the deployability score is further based on the plurality of time periods.

8. The employee evaluation system of claim 1, wherein a category of the plurality of categories comprises a plurality of jobs, wherein the plurality of jobs corresponds to a plurality of time periods, wherein the calculating of the deployability score is further based on the plurality of time periods.

9. The employee evaluation system of claim 1, wherein the communication device is further configured for:
receiving a deployability request from a requesting device, wherein the deployability request comprises the employee identifier; and
transmitting a plurality of deployability scores corresponding to a plurality of job data to the requesting device, wherein the plurality of deployability scores is associated with the employee identifier, wherein the storage device is further configured for retrieving the plurality of deployability scores based on the employee identifier.

10. The employee evaluation system of claim 1, wherein the communication device is further configured for receiving a social score from the user device, wherein the calculating of the deployability score is further based on the social score.

11. A method for evaluating an employee, the method comprising:
receiving, using a communication device, a plurality of points corresponding to a plurality of categories associated with an employee from a user device;
receiving, using the communication device, a job data from the user device;
calculating, using a processing device, a deployability score associated with the employee based on the plurality of points and the job data;
storing, using a storage device, the deployability score in association with an employee identifier of the employee and the job data; and
transmitting, using the communication device, the deployability score to the user device.

12. The method of claim 11, wherein the plurality of categories comprises education, certifications, skills and job history.

13. The method of claim 11 further comprising generating, using the processing device, the deployability score based on a weighted sum of the plurality of points, wherein the weighted sum is based on addition of a plurality of products of the plurality of points and corresponding plurality of weights associated with the plurality of categories.

14. The method of claim 11, wherein the plurality of categories corresponds to a plurality of weights, wherein each weight of the plurality of weights is based on the job data, wherein the deployability score is further based on the plurality of weights.

15. The method of claim 14, wherein each weight comprises an industry coefficient adjustment corresponding to the job data, wherein the job data comprises at least one of a job type and an industry.

16. The method of claim 11, wherein at least one category of the plurality of categories comprises a plurality of sub-categories, wherein the plurality of sub-categories is associated with a plurality of sub-category points, wherein a points associated with a category is based on the plurality of sub-category points associated with the plurality of sub-categories of the category.

17. The method of claim 11, wherein the plurality of categories is associated with a plurality of time periods, wherein the calculating of the deployability score is further based on the plurality of time periods.

18. The method of claim 11, wherein a category of the plurality of categories comprises a plurality of jobs, wherein the plurality of jobs corresponds to a plurality of time periods, wherein the calculating of the deployability score is further based on the plurality of time periods.

19. The method of claim 11 further comprising:
receiving, using the communication device, a deployability request from a requesting device, wherein the deployability request comprises the employee identifier; and
transmitting, using the communication device, a plurality of deployability scores corresponding to a plurality of job data to the requesting device, wherein the plurality of deployability scores is associated with the employee identifier, wherein the storage device is further configured for retrieving the plurality of deployability scores based on the employee identifier.

20. The method claim 11 further comprising receiving a social score from the user device, wherein the calculating of the deployability score is further based on the social score.
